(19) United States
(12) Patent Application Publication
(10) Pub. No.: US 2020/0325666 A1
(43) Pub. Date: Oct. 15, 2020

(54) One way Valve For Water Fixture

(71) Applicants: Christopher Kapsaskis, Freehold, NJ (US); Joseph Cirillo, Manalapan, NJ (US); Zachary Grassi, Freehold, NJ (US); John Kosowski, Oak Brook, IL (US); Ye Yaoru, Xiamen (CN)

(72) Inventors: Christopher Kapsaskis, Freehold, NJ (US); Joseph Cirillo, Manalapan, NJ (US); Zachary Grassi, Freehold, NJ (US); John Kosowski, Oak Brook, IL (US); Ye Yaoru, Xiamen (CN)

(21) Appl. No.: 16/574,665

(22) Filed: Sep. 18, 2019

Related U.S. Application Data
(60) Provisional application No. 62/832,120, filed on Apr. 10, 2019.

(51) Int. Cl. E03C 1/298; F16K 15/14; E03B 7/07

(52) U.S. Cl. CPC E03C 1/298; E03B 7/077; F16K 15/14

(57) ABSTRACT

A one way valve for a waste pipe of a water fixture such as a bathroom or kitchen sink includes an elastomeric tube having a funnel or conical shaped inlet and transitioning into a pair of flat walls which separate to pass fluid under hydraulic pressure in a forward direction but remain closed together to block fluid or gas flow under backpressure, in a reverse direction. A guard or blocking member or other configuration prevents the tube from inverting into an unrecoverable inversion position when subject to excessive back pressure.

This application claims the benefit of US Provisional Application Ser. No. 62/832120, filed Apr. 10, 2019.

### BACKGROUND

Sinks, and other kitchen or bathroom water fixtures are provided P-traps to provide a barrier between the fixture and a waste pipe that leads to a sewer. P-traps stop gas and odors from the sewer from backflow from the domestic waste pipe through the fixture and into the dwelling or building. Water in the P-trap stops the backflow of gases and odors but allows the passage of water and waste though the P-trap.

P-traps have disadvantages, such as the space needed beneath the water fixture to pipe the P-trap, from the fixture drain to the domestic waste pipe.

U.S. Pat. No. 7,509,978 discloses a P-trap replacement device that includes a flat silicone rubber tubing defining a pair of walls which separate to admit fluid in a forward direction but remain together to block fluid flow in a reverse direction.

FIG. 1 from prior art U.S. Pat. No. 7,509,978 shows a non-return device 10. A flexible tube 30 made from silicone rubber is located inside a pipe 36. The tube 30 comprises two opposite flat walls 40, 42 which are connected to each other along mutual side edges, extending along the length of the tube. In a lower region 43, the flat walls, in a relaxed or water-empty condition, are closed against each other. In an upper region 45, the flat walls transition and expand into a substantially conical configuration. The walls 40, 42 are held apart from each other in the conical configuration, to a top circular inlet opening. The walls are stretched radially over a generally annular cartridge 52.

The cartridge 52 is axially movable within a mouth 60 of the pipe. The cartridge 52 also comprises a radially outwardly extending flange 64, which seats upon and abuts an axially-facing end flange 70 of the pipe. The two flanges 64, 70 are received within an annular recess 76 of a nut 80. The nut 80 is provided with a threaded mouth 84. An annular sealing ring 90 is situated on the cartridge 52, so as to face in the axial direction into the mouth of the nut 80. The sealing ring 90 surrounds an upper end of the cartridge 52.

The device 10 is installed on a waste outlet 110 by screwing the nut 80 onto a correspondingly threaded outer surface of the waste outlet. The nut 80 is turned and tightened to pull the pipe 36, the cartridge 52 and the tube 30 in an upward direction (as oriented in FIG. 3), by moving the flanges by the nut 80. After the nut 80 has reached a certain point, an axial end of the waste outlet 110 will abut the sealing ring 90. As the nut 80 is turned further, the pipe 36 will continue to travel, urging the cartridge 52 still further in the upward direction by moving the flanges. This will compress sealing ring 90, effecting a first seal between the waste outlet 110 and the cartridge 52. As the nut 80 is turned still further, the tube 30 is compressed between the cartridge 52 and the pipe 36. This will effect a second compression seal between the cartridge 52 and the pipe 36.

The device of U.S. Pat. No. 7,509,978 provides a compact replacement for the conventional p-trap.

However, the present inventors have recognized that one drawback to the P-trap replacement device of U.S. Pat. No. 7,509,978, is an issue of backflow under excess back pressure conditions. Under excess backpressure, the tube 30 can invert or turn inside out as indicated in dashed lines in FIG. 1, with the flat walls 40, 42 passing into the waste pipe 110, the flat walls opening away from each other into a cylinder, or two lobed or oval cylinder shape with an open end 43. The walls will not return to normal function, by returning to the normal operating position, without maintenance. In this inverted position shown in dashed lines in FIG. 1, with the flat walls open to each other, the device will not be closed to prevent odors from passing through the tube and into the waste pipe 110, and through the water fixture, such as a sink. Additionally, water cannot pass out of the water fixture.

The present inventors have recognized that it would be desirable to provide a P-trap replacement device that overcomes the drawbacks of the prior art, is long lasting and effective, and reduces the necessity of maintenance.

### SUMMARY

The embodiment of the present invention provides a one way valve that replaces P-trap devices and that overcomes the drawbacks of the prior art P-trap replacement devices. The one way valve includes an elastomeric tube having an upper funnel-shaped or conical shaped upper portion and defining in a lower portion a pair of flat walls which separate to pass fluid under hydraulic pressure in a forward direction but remain together to block reverse direction fluid or gas flow under backpressure, and also includes a guard or blocking member or other configuration that prevents the tube from inverting into an unrecoverable position when subject to excessive back pressure.

In a one way valve having a valve body and an elastomeric tube mounted within the valve body, the tube having an open top end for receiving waste water and a normally closed bottom end to prevent reverse flow of gas but openable by waste water, the valve body having an inlet end and an outlet end, one exemplary embodiment of the invention includes a physical blocking member within the valve body arranged between the inlet end and the open top, the physical blocking member having structure preventing the passing of the tube past the physical blocking member when subject to excessive back pressure, but allows waste water to pass through the physical blocking member.

The physical blocking member can be a guard comprising an annular ring and at least one rail within the annular ring, the rail preventing inversion of the tube.

The improvement can include a cartridge having an annular body arranged between the guard and the inlet, the cartridge providing a surrounding surface that is surrounded by the open end of the tube, wherein the surrounding surface traps the open end of the tube against an inside surface of the valve body.

The guard can be fixed to an end surface of the cartridge or can be molded integrally with the cartridge.

The cartridge can include a first annular flange and the valve body can include an upper flange arranged facing the first annular flange. The cartridge can include a second annular flange located between the first annular flange and the open end of the tube, wherein the first flange is pressed against the upper flange and the upper end of the tube is captured between the first and second flanges and the valve body when the upper nut is fully tightened along the waste pipe.

Another exemplary embodiment of the invention provides that, instead of a blocking member, one or both flat walls of the tube is (are) attached to a part of the valve body preventing inversion of the tube when subjected to excess back pressure.

Another exemplary embodiment of the invention provides that, instead of a blocking member, one side or edge of the two flat walls is directly attached to the valve body preventing inversion of the tube when subjected to excess back pressure.

Another exemplary embodiment of the invention provides that, instead of a blocking member, a bottom portion of the tube is restricted by a surrounding fitting or guide fixed to the valve body preventing inversion of the tube when subjected to excess back pressure.

Another exemplary embodiment of the invention provides that, instead of a blocking member, a stiffening ring is attached to and around the tube preventing inversion of the tube when subjected to excess back pressure.

Another exemplary embodiment of the invention provides that, instead of a blocking member, a stiffening rib secured lengthwise along the tube preventing inversion of the tube when subjected to excess back pressure.

Another exemplary embodiment of the invention provides that, instead of a blocking member, the stiffness of the tube is increased preventing inversion of the tube when subjected to excess back pressure. The stiffness can be increased by choice of tube material or thickness of the wall of the tube.

Another exemplary embodiment of the invention provides that, instead of a blocking member, the shaping of the tube is configured as a cone substantially along the length of the tube preventing inversion of the tube when subjected to excess back pressure.

Another exemplary embodiment of the invention provides that, instead of a blocking member, a magnet and a magnetic receptive body mounted one to each of the tube and the valve body. Magnetic interaction between the magnet and the magnetic receptive body prevents the passing of the tube past the inlet of the valve body

An exemplary composition of the one way valve includes a polypropylene valve body enclosing and anchoring a silicone tube, with an EPDM rubber gasket to seal the connections.

The embodiment of the invention allows the valve to recover from an inversion condition by blocking or otherwise preventing the tube from complete inversion. The next flow of water through the valve should re-orient the tube.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a vertical sectional view of a prior art one way valve;

FIG. 2 is an elevation view of one embodiment of a one way valve according to the invention, connected to upper and lower pipes;

FIG. 3 is an enlarged fragmentary partial sectional view of the one way valve of FIG. 2;

FIG. 4 is an exploded, schematic, perspective view of the one way valve of FIG. 2;

FIG. 5a is a plan view of a guard taken from FIG. 3;

FIG. 5b is a plan view of a first alternate guard taken from FIG. 3;

FIG. 5c is a plan view of a second alternate guard taken from FIG. 3;

FIG. 5d is a plan view of a third alternate guard taken from FIG. 3;

FIG. 5e is a plan view of a fourth alternate guard taken from FIG. 3;

FIG. 6a is a schematic side profile of a second embodiment appliance one way waste valve of the invention;

FIG. 6b is a schematic side profile of a third embodiment appliance one way waste valve of the invention;

FIG. 6c is a schematic side profile of a fourth embodiment appliance one way waste valve of the invention;

FIG. 6d is a schematic side profile of a fifth embodiment appliance one way waste valve of the invention;

FIG. 6e is a schematic side profile of a sixth embodiment appliance one way waste valve of the invention;

FIG. 6f is a schematic side profile of a seventh embodiment appliance one way waste valve of the invention; and

FIG. 6g a schematic side profile of is an eighth embodiment appliance one way waste valve of the invention.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

This application incorporates by reference U.S. Provisional Application Ser. No. 62/832120, filed Apr. 10, 2019, and U.S. Pat. No. 7,509,978, both in their entireties.

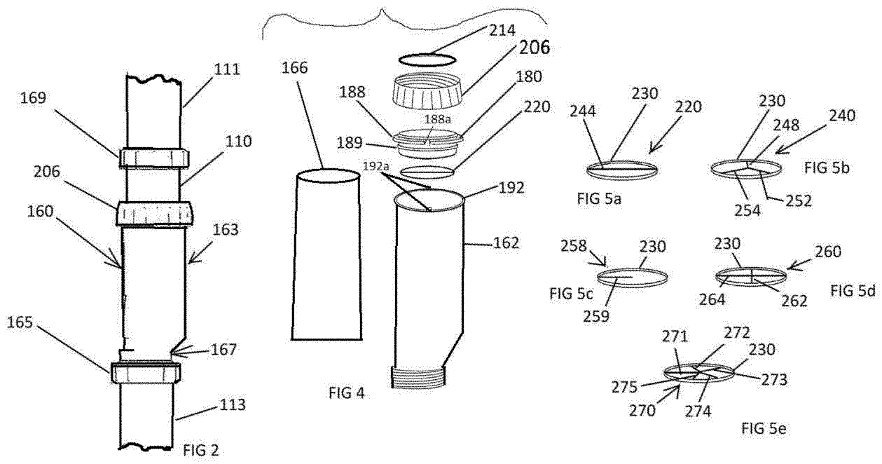

FIG. 2 illustrates an elevation view of an appliance one way valve 160 of the invention. The valve includes a substantially cylindrical valve body 162 having an upper portion 163 carrying an upper nut 206 that secures the pipe to a waste pipe 110. A further nut 169 can connect a further waste pipe 111 to the waste pipe 110. The further outlet pipe 111 can be from a water fixture, such as from the waste pipe or drain pipe of a sink. A lower portion 167 of the valve body 162 carries a second nut 165 for securing the valve 160 to a discharge waste pipe 113. The lower portion 167 of the valve body 162 can be axially eccentric to the upper portion 163 an eccentric lower pipe portion and of a lesser diameter for connecting to the discharge waste pipe 113. The discharge waste pipe can be flow connected to a domestic waste pipe or other disposal destination.

The nuts 165, 169 are threaded onto the pipe 110 and onto the lower portion 167 and when tightened each compress an annular seal to seal around the pipes 111, 113 respectively, this type of seal being known. Loosening of the nuts 165, 169 will allow the easy removal of the valve 160 for replacement of maintenance.

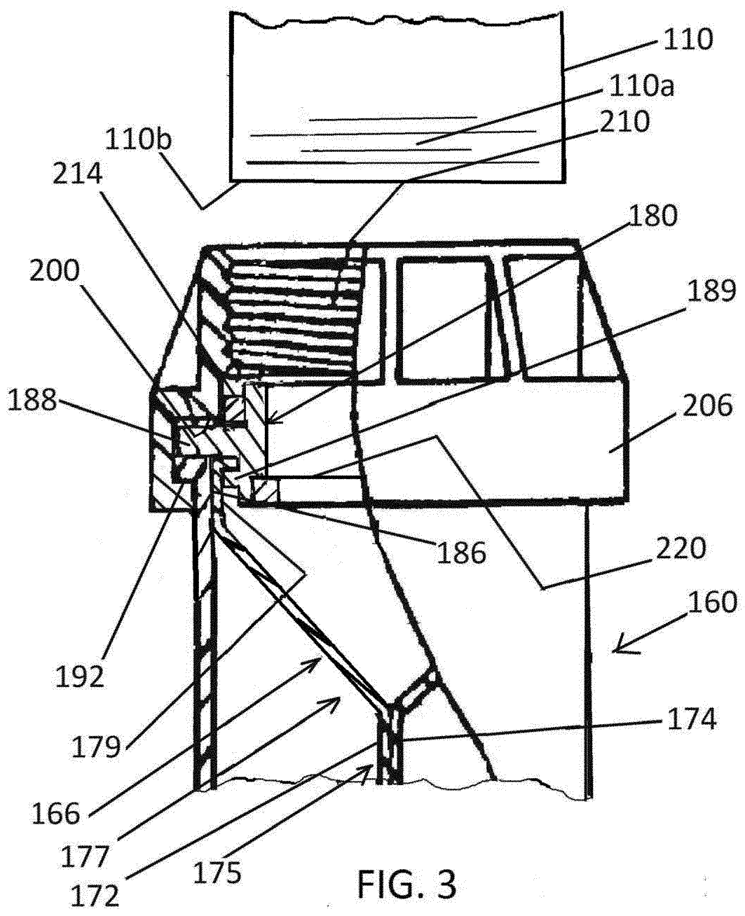

FIGS. 3 and 4 show the valve 160 according to one embodiment of the invention. A flexible tube 166, such as one made from silicone rubber, is located inside the valve body 162. The sleeve can have a thickness of about 0.75 millimeters. The tube 166 comprises two opposite flat walls 172, 174 which are sealed to each other along mutual side edges, extending along the length of the tube. In a lower regions 175, the tube is pre-formed such that the flat walls 172, 174, in a relaxed condition, not exposed to hydraulic pressure from above, are closed against each other. In an upper region 177, the flat walls transitions and expands into a funnel-shaped or substantially conical configuration. In the upper region 177, the walls 172, 174 are held apart from each other, to a top circular inlet opening 179. The walls are stretched radially over a generally annular cartridge 180. The flat walls can have a width (into the page) of approximately equal to a diameter of the top circular inlet opening. Alternately, the width can be lesser or greater than the diameter of the top circular inlet opening.

The cartridge 180 is located over a top opening 186 of the pipe. The cartridge 180 also comprises a radially outwardly extending flange 188, which seats upon and abuts an axially facing end surface of the valve body 162, which is defined by a further radially-outwardly facing flange 192. The flange 188 can include two notches 188a, at 180 degrees apart around the circumference of the flange 188, and the flange 192 can include two detents 192a, which fit into the two notches 188a when the cartridge 180 is placed down onto the valve body 162. The interaction of the notches 188a and the detents 192a prevent relative rotation of the cartridge 180 and the valve body 162 during tightening of the nut 206. The cartridge 180 also includes a second flange or circumferential nub 189, extending radially to a lesser extent than the flange 188 and spaced below the flange 188. The two flanges 188, 192 are received within an annular recess 200 of the nut 206. The nut 206 is provided with a threaded opening 210. An annular sealing ring 214 is situated on the cartridge 180. The sealing ring 214 surrounds an upper end of the cartridge 180, surrounding the cartridge 180 and surrounded by the nut 206.

The valve 160 is installed onto a waste pipe 110 by screwing the nut 206 onto a correspondingly threaded outer surface 110a of the waste pipe. The nut 206 is turned and tightened to pull the valve body 162, the cartridge 180 and the tube 166 in an upward direction (as oriented per FIG. 3), because of the location of the flanges 188, 192 within the annular recess 200 of the nut 206. After the nut 206 has reached a certain point, an axial, annular end 110b of the waste outlet 110 will abut the sealing ring 214. As the nut 206 is turned further, the valve body 162 will continue to move, urging the cartridge 180 still further in the upward direction by force on the flanges 188, 192. This will compress sealing ring 214, effecting a first seal between the waste outlet 110 and the cartridge 180. As the nut 206 is turned still further, the valve body 162 will still be urged upwardly. This will then cause the tube 166 to be compressed between the cartridge 180 and the valve body 162, bent off between the two flanges 188, 189 of the cartridge. This will effect a second compression seal between the cartridge 180 and the valve body 162.

A guard or grate 220 is provided on or adjacent to the cartridge 180. Alternately, the guard can be on the bottom or on the top of the cartridge. Alternately, the guard can be molded integrally with the cartridge. Alternately, the guard can be snap fitted into the cartridge, or adhesively secured thereto or welded thereto.

FIG. 5a shows the guard 220 in more detail. The guard 220 includes an annular rim 230 and a single rail 244 that spans across the rim.

FIG. 5b shows an alternate embodiment guard 240 having the annular rim 230 and three rails 248, 252, 254, each extending from the annular rim 230 evenly spaced at about a 120 degree spacing and connected at a center of the rim 230.

FIG. 5c shows an alternate embodiment guard 258 having a single rail 259 that extends radially from the rim 230, partially across the rim.

FIG. 5d shows an alternate embodiment guard 260 having two rails 262, 264 that extend radially from the rim 230 and intersect at the center of the rim and are arranged at a 90 degree angle to each other.

FIG. 5e shows an alternate embodiment guard 270 having five rails 271, 272, 273, 274, 275 arranged extending radially from the rim 230, evenly spaced apart by about 72 degrees and each terminating at the center where the rails are connected together.

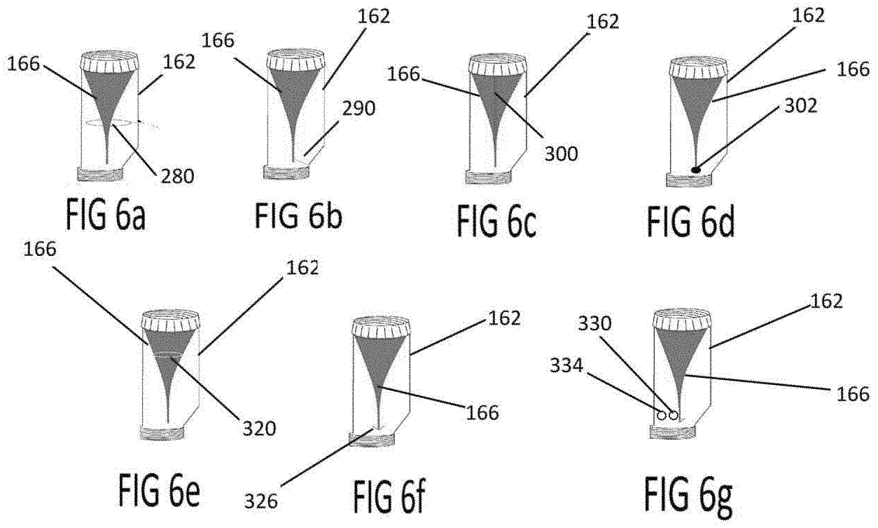

FIG. 6a shows an alternate embodiment wherein instead of a guard, a guide or fitting 280 is provided within the valve body, secured at 290 to an inside of the valve body, and surrounding the tube.

FIG. 6b shows an alternate embodiment wherein instead of a guard, a tether or link 290 is provided within the valve body, secured to an inside of the valve body and attached to the flat walls at the lower portion of the tube.

FIG. 6c shows an alternate embodiment wherein instead of a guard, a stiff spine or rib 300 is attached to one of the walls which prevents the inversion of the tube.

FIG. 6d shows an alternate embodiment wherein instead of a guard, one or both of the walls is (are) connected directly at attachment 302 to an inside of the valve body by adhesive, welding or other method which prevents the inversion of the tube.

FIG. 6e shows an alternate embodiment wherein instead of a guard, a stiffening element, such as a ring 320 is fixed to an inside or an outside of the tube, particularly in the upper conical portion, to prevent the inversion of the tube.

FIG. 6f shows an alternate embodiment wherein instead of a guard, the tube has a shape oriented to prevent the inversion of the tube. The sleeve can have a conical shape with a bottom end rolled outward around itself, forming a cuff 326. The cuff acts to stiffen the tube 166 at a bottom end, preventing inversion.

FIG. 6g shows an alternate embodiment wherein instead of a guard, the tube is provided with an attached magnet 330 and the valve body has an attached magnetic receptive body 334 attracted by the magnet. The magnetic attraction between the magnet and the magnetic receptive body prevent the inversion of the tube. Alternately the magnet can be mounted to the valve body and the magnetic receptive body can be mounted to the tube.

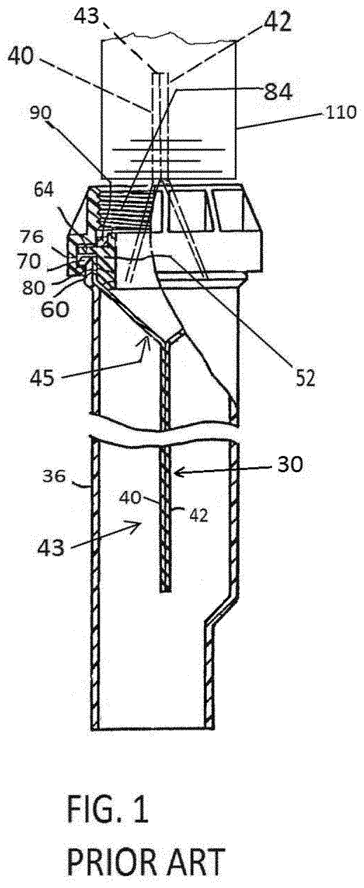

Because of the rails of any of the above described guards, or the other methods described in FIGS. 6a-6g, the tube 166, even under excessive back pressure, is prevented from inverting as shown in dashed lines in FIG. 1.

From the foregoing, it will be observed that numerous variations and modifications may be effected without departing from the spirit and scope of the invention. It is to be understood that no limitation with respect to the specific apparatus illustrated herein is intended or should be inferred.US

1. In an one way valve having a valve body and an elastomeric tube mounted within the valve body, the tube having an open end for receiving water and a normally closed opposite end to prevent reverse flow of gas but openable by hydraulic pressure to allow flow of water from the open end to the opposite end, the valve body having an inlet end and an outlet end, the improvement comprising:
the valve body composed of thermoplastic having a female threaded inlet end and a threaded outlet end, the valve sized for under-sink plumbing:
the tube composed of rubber:
a physical blocking member within the valve body having structure limiting the movement of the opposite end of the tube, to prevent inversion of the tube subject to a back pressure condition, in a direction from the outlet end toward the inlet end, but allowing waste water to pass in a direction from the inlet end toward the outlet end, the physical blocking member comprising a single rib or spine extending lengthwise from the open end of the tube toward the normally closed opposite end.

2. (canceled)

3. The improvement according to claim 1, wherein the physical blocking member comprises an annular ring and at least one rail within the annular ring, the rail preventing inversion of the tube.

4. The improvement according to claim 1, wherein the physical blocking member comprises an annular ring, wherein the annular ring extends down inside and below the open end of the tube.

5. The improvement according to claim 1, wherein the physical blocking member comprises an annular ring.

6. The improvement according to claim 1, wherein the physical blocking member extends down inside and below the open end of the tube.

7. The improvement according to claim 1, wherein the physical blocking member comprises an annular ring and comprising a cartridge having an annular body arranged between the annular ring and the inlet, the cartridge providing a surrounding surface that is surrounded by the open end of the tube, wherein the surrounding surface traps an end portion of the tube against an inside surface of the valve body.

8. The improvement according to claim 7, wherein the annular ring is fixed to an end surface of the cartridge.

9. The improvement according to claim 7, wherein the cartridge includes a first annular flange and the valve body includes an upper flange arranged facing the first annular flange, and the cartridge includes a second annular flange located between the first annular flange and the open end of the tube, wherein the first flange is pressed against the upper flange and an upper end portion of the tube is captured between the first and second flanges and the valve body when the valve body is tightened onto a waste pipe.

10. A method of preventing inversion of a one way valve sized for under sink installation, the one way valve having a valve body and an elastomeric tube mounted within the valve body, the tube having an open end for receiving water and a normally closed opposite end to prevent reverse flow of gas but openable by hydraulic pressure to allow flow of water from the open end to the opposite end, the valve body having an inlet end and an outlet end, comprising the steps of:
providing the valve body composed of a thermoplastic having a female threaded inlet end and a threaded outlet end, the valve sized for under-sink plumbing;
providing the tube composed of rubber;
providing a single rib or spine extending from the open end of the tube toward the normally closed opposite end that allows the tube to pass water through the tube in a direction from the open end toward the opposite end and prevents gas flow in a reverse direction, and prevents inversion of the tube when subject to excessive back pressure.

11. (canceled)

12. The method according to claim 10, wherein the mechanism is an attachment of the tube closed bottom to the valve body.

13. (canceled)

14. The method according to claim 10, wherein the mechanism is a magnet and a magnetic receptive object, each connected to one of the tube and the valve body respectively.

15. The method according to claim 10, wherein the single rib or spine is attached to the tube.

16. The improvement according to claim 1, wherein the single rib or spine is attached to the tube.
